(19) United States
(12) Patent Application Publication
(10) Pub. No.: US 2011/0245741 A1
(43) Pub. Date: Oct. 6, 2011

(54) Massage Apparatus with Removable Rollers

(76) Inventors: Robert N. L'Homme, Attleboro, MA (US); Thomas J. Marcotte, Plainville, MA (US)

(21) Appl. No.: 13/074,515

(22) Filed: Mar. 29, 2011

Related U.S. Application Data
(60) Provisional application No. 61/318,818, filed on Mar. 30, 2010.

(51) Int. Cl. A61H 15/00

(52) U.S. Cl. 601/120

(57) ABSTRACT

A massage apparatus that includes an elongate member having a length defined by a first end and a second end; a first handle connected to the first end of the apparatus and a second handle connected to the second end of the apparatus; and a plurality of rollers, the plurality of rollers slidably disposed along the elongate member, each roller includes an outer surface, an interior cavity defined by the outer surface, wherein the interior cavity comprises a freezable liquid suitable for storing thermal energy for a time period P when in a liquid state; and a hollow portion sized to fit around the elongate member.

### CROSS-REFERENCE TO RELATED APPLICATION

This application claims priority to and the benefit of U.S. Provisional Patent Application No. 61/318,818, filed Mar. 30, 2010, the entire disclosure of which is hereby incorporated by reference herein.

### FIELD OF INVENTION

The present invention relates to a massage device and related methods suitable for therapeutic and other purposes.

### BACKGROUND

Massage devices are of great value for athletes and individuals seeking relief from the discomfort associated with tense, sore muscles and cramps. Some benefits of massage therapy can include decreased anxiety, enhanced sleep quality, greater energy, improved concentration, increased circulation, and reduced fatigue.

There are massage sticks that relieve tense, sore muscles and cramps. Such muscle massage sticks fail to provide additional therapeutic effects beyond basic massage relief. Therefore, there exists a need for a massage apparatus that incorporates additional features and characteristics.

### SUMMARY

The present invention relates to a massage apparatus with removable, fluid-filled rollers. The apparatus can include a plurality of hollow rollers disposed around an elongate member such as a support stick or rod. The support stick or rod can be straight, curved, triangular, rectangular, square, U-shaped, or other geometric shape. In one embodiment, the rollers can be substantially donut-shaped.

In one massage apparatus embodiment, each roller includes a cavity or volume that can store a fluid, such as a gel or liquid and be removable from the support stick. The support stick, elongate member or core, along which the rollers can be slidably disposed can be flexible, rigid, hollow or solid in various embodiments. In one embodiment, the support stick, elongate member or core along which the rollers can be disposed can be fluid fillable and contain a hot liquid, steam, ice, or a cold liquid.

The apparatus can include two handles located at either end of the support stick, either or both of the handles are removable or detachable from the support stick. This design feature allows the rollers to be placed onto or taken off the support stick. In certain embodiments, at least one handle can be made of a grip friendly, compressible, or ergonomic material.

The support stick may be made of any suitable material, such as a light plastic or polymer. The support stick can be about 16 inches to about 2.5 feet long. In one embodiment, a plurality of rollers are sized to slide onto the support stick along a hole in each roller. Such sliding or installation of rollers is possible once either or both of the handles at the ends of the support stick are removed.

The fluid-filled rollers can be ring-shaped with a hollow cavity or volume defined by a shell or housing. Each roller can be sized to fit around the support stick, and can be filled with a suitable fluid or a solid thermal energy storage material. The rollers can be about 2 inches long and about 1 inch thick. In certain embodiments, the rollers can be less than or greater than 2 inches long. In particular embodiments, the rollers can be less than or greater than 1 inch thick.

The handles on either end of the support stick can be made of a suitable material, such as rubber or plastic, and are removable from the support stick. In one embodiment, the handles can be removed by twisting or unscrewing the handle. Alternatively, a handle can be attached to or removed from the support stick by a moveable button on the support stick that engages and disengages a corresponding hole on the handle. Twisting or unscrewing one or both handles to separate from the support stick can allow for one or more of the rollers to be removed.

In one embodiment, the support stick with removable fluid-filled rollers can be used by removing one or both handles, removing the rollers, heating or cooling the rollers, and placing the rollers back onto the support stick and reattaching the removed handles. The massage device can then be applied to an area of a body and rolled back and forth in any direction to relieve tense, sore muscles or cramps. In particular embodiments, the plurality of rollers can be detached by clipping or snapping the plurality of rollers off the elongate member. The support stick or elongate member along which the rollers are disposed can be flexible, deformable or otherwise stretchable. In one embodiment, the core includes a spring or other position retaining or memory element that retains a given shape after manipulation by a user. The core or elongate member can be curved to form a U-shape or other curved shaped along which the rollers can still rotate. In one embodiment, the support stick or elongate member can vibrate. In one embodiment, the support stick or elongate member can be electrically charged for example by plugging an electric cord into a suitable electric outlet.

In one embodiment, the invention relates to a method of massaging an area of a body. The method includes the steps of removing a plurality of rollers from an elongate member having a length defined by a first end and a second end; a first handle connected to the first end of the apparatus and a second handle connected to the second end of the apparatus; and the plurality of rollers, the plurality of rollers capable of placement on the elongate member, the rollers comprising an interior cavity wherein the interior cavity contains a substance adaptable to heating or cooling; heating some or all of the plurality of rollers to a desired temperature; cooling some or all of the plurality of rollers to a desired temperature; placing the plurality of rollers onto the elongate member; maneuvering the elongate member across the area of the body; and applying a force such that the plurality of rollers contact and apply pressure to the area of the body.

In one embodiment, the invention relates to a massage apparatus comprising: an elongate member having a length defined by a first end and a second end; a first handle connected to the first end of the apparatus and a second handle connected to the second end of the apparatus; and a plurality of rollers slidably disposed along the elongate member, each roller comprising: an outer surface, an interior cavity defined by the outer surface, wherein the interior cavity comprises a freezable or heatable liquid suitable for storing thermal energy for a time period P when in a liquid state; and a hollow portion having an inner surface sized to receive the elongate member. In one embodiment, the rollers can each be separated by one or more spacers. In one embodiment, the length of the elongate member can be about 16 inches to about 2.5 feet. In one embodiment, one or both of the first handle and the second handle can be removable.

In one embodiment, the plurality of rollers can be ring-shaped. In one embodiment, the rollers comprise at least one of plastic, ceramic, or stone. In one embodiment, the plurality of rollers slide onto the elongate member after one or both of the first handle and the second handle is removed. In one embodiment, the plurality of rollers clip on to the elongate member without removing one or both of the first handle or the second handle.

In one embodiment, the substance in each roller stores or rejects heat. In one embodiment, the liquid or gel comprises at least one of water, sodium chloride, minerals, cellulose, propylene glycol, hydroxypropyl methylcelluose, polyacrylate, and polyalcohol. In one embodiment, the liquid or gel is selected from the group consisting of water or a suitable pre-made composition.

In one embodiments, the invention relates to a massage apparatus comprising: a plurality of removable rollers, each roller comprising a donut-shaped shell and a liquid disposed within the shell, the shell having an outer diameter and defining a hole having an inner diameter; a substantially cylindrical core having a core diameter, a first handle receiving end and a second handle receiving end, wherein the core diameter is sized relative to the inner diameter such that the core can slidably receive each roller and allow each roller to rotate relative to the core; and a first handle and a second handle, each handle having an attachment point for connecting to one of the first handle receiving end or the second handle receiving end, wherein the liquid freezes in response to a reduction in temperature and stores heat in response to an increase in temperature, wherein after heating, the liquid stores thermal energy for at a least time period P.

This Summary is provided merely to introduce certain concepts and not to identify any key or essential features of the claimed subject matter.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

### BRIEF DESCRIPTION OF THE DRAWINGS

The present teachings described herein will be more fully understood from the following description of various illustrative embodiments, when read together with the accompanying drawings. It should be understood that the drawings described below are for illustration purposes only and are not intended to limit the scope of the present teachings in any way. The invention is pointed out with particularity in the appended claims. In the drawings, like reference characters generally refer to the same parts throughout the different views. The drawings are not necessarily to scale, emphasis instead generally being placed upon illustrating the principles of the invention.

FIG. 1A is a schematic diagram that depicts a perspective view of a massage apparatus according to an illustrative embodiment of the invention.

FIG. 1B is a schematic diagram that depicts a front view of a massage apparatus according to an illustrative embodiment of the invention.

FIG. 2A is a schematic diagram that depicts a perspective view of an elongate member according to an illustrative embodiment of the invention.

FIG. 2B is a schematic diagram that depicts a front view of an elongate member according to an illustrative embodiment of the invention.

FIG. 3A is a schematic diagram that depicts a side view of a massage apparatus including beads or spacers positioned between the rollers according to an illustrative embodiment of the invention.

FIG. 3B is a schematic diagram that depicts a front view of the massage apparatus including spacers positioned between the rollers according to an illustrative embodiment of the invention.

FIG. 4A is a schematic diagram that depicts a perspective view of a roller according to an illustrative embodiment of the invention.

FIG. 4B is a schematic diagram that depicts a cross-sectional view of a roller according to an illustrative embodiment of the invention.

FIG. 4C is a schematic diagram that depicts a front view of a roller according to an illustrative embodiment of the invention.

FIG. 5A is a schematic diagram that depicts a perspective view of the handle according to an illustrative embodiment of the invention.

FIG. 5B is a schematic diagram that depicts another view of a handle that in a detached state according to an illustrative embodiment of the invention.

### DETAILED DESCRIPTION

The present invention relates to a massage apparatus suitable for therapeutic and other purposes. Athletes and individuals seeking relief from tense, sore muscles and cramps can benefit from using the massage apparatus described herein. The following description refers to the accompanying drawings that illustrate certain embodiments of the invention. Other embodiments are possible and modifications may be made to the embodiments without departing from the spirit and scope of the invention. Therefore, the following detailed description is not meant to limit the present invention. Rather, the scope of the present invention is defined by the appended claims.

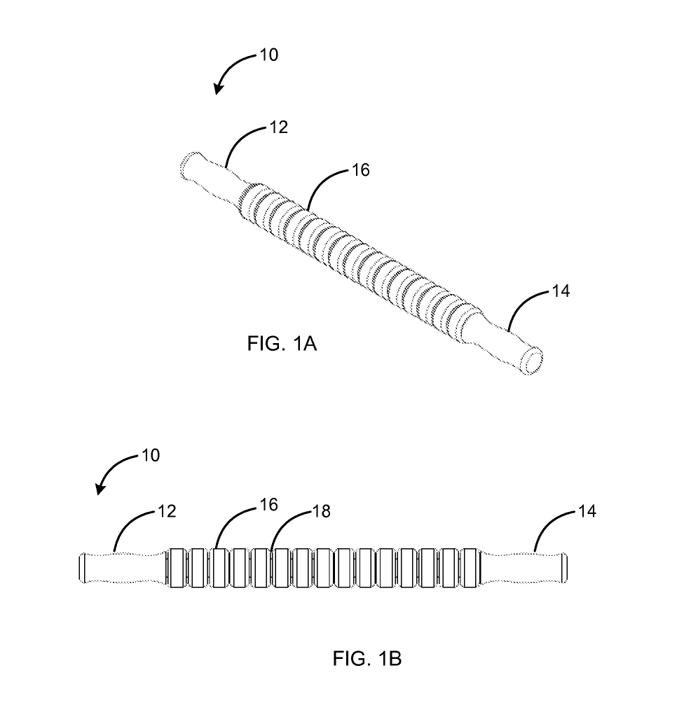

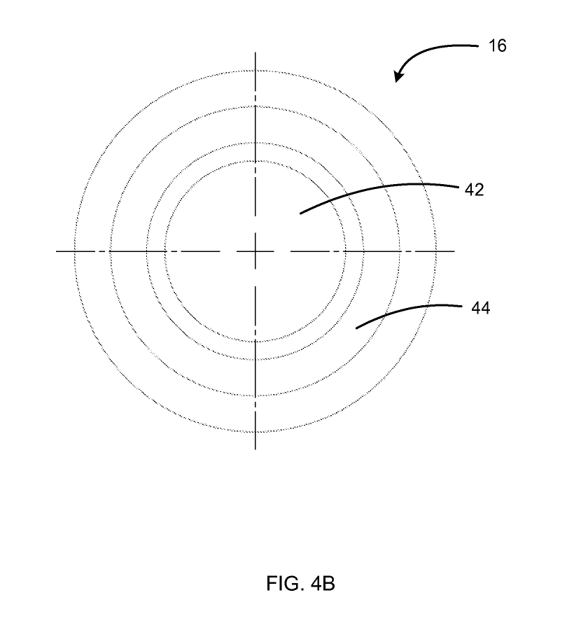

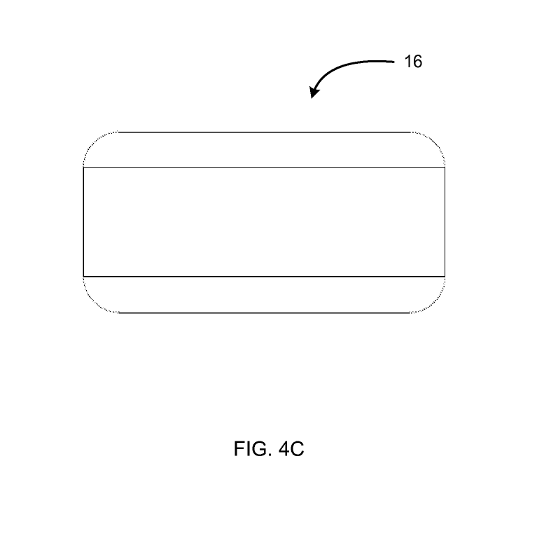

FIG. 1A is a schematic diagram that depicts a perspective view of a massage apparatus 10 according to an illustrative embodiment of the invention. FIG. 1B is a schematic diagram that depicts a front view of a massage apparatus 10 according to an illustrative embodiment of the invention. The massage apparatus 10 can include an elongate member or core 18 having a length defined by a first end and a second end; a first handle 12 connected to the first end of the therapeutic massage apparatus and a second handle 14 connected to the second end of the massage apparatus; and a plurality of rollers 16, the plurality of rollers 16 capable of rotation with the elongate member 18 as an axis. In one embodiment, the rollers 16 can include an interior cavity 44 (as shown in FIG. 4B). In one embodiment, the interior cavity 44 can contain a substance that can tolerate heating or cooling; and a hollow center portion 42, the hollow portion 42 sized to fit around and receive the elongate member or core 18.

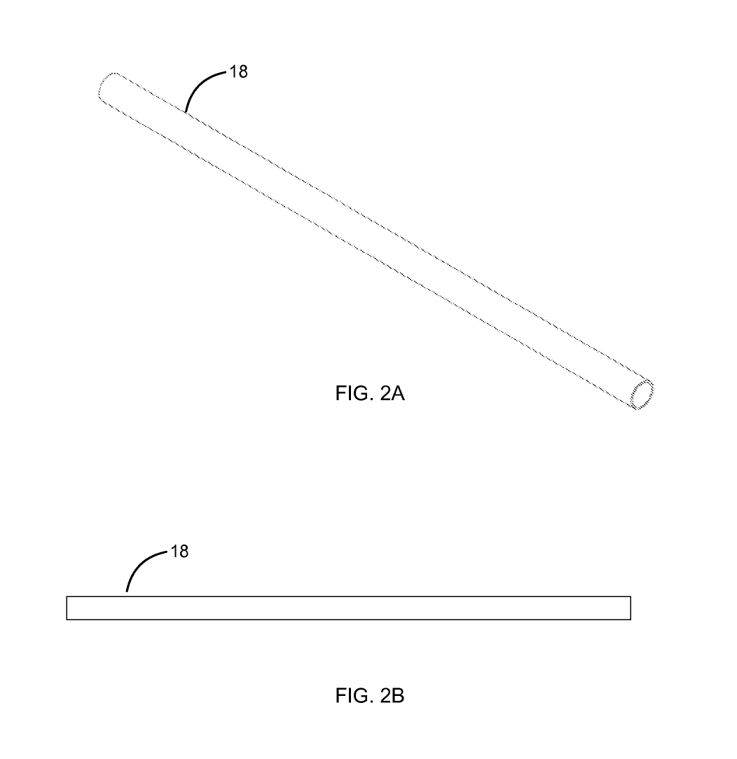

FIG. 2A is a schematic diagram that depicts a perspective view of an elongate member 18 according to an illustrative embodiment of the invention. FIG. 2B is a schematic diagram that depicts a front view of an elongate member 18 according to an illustrative embodiment of the invention. In certain embodiments, the elongate member 18 can be made of any suitable material, such as plastic, metal, or ceramic. The elongate member 18 can be hollow, solid, or mesh. In some embodiments, the elongate member 18 can be made of a suitable material such that the elongate member 18 can be flexible. Generally, the elongate member is about 16 inches to about 2.5 feet; however, the elongate member can also be less than 16 inches or greater than 2.5 feet. The elongate member can include a memory retaining material. In addition, the elongate member 18 can include a heating element that includes batteries or can be recharged.

In some embodiments, the elongate member 18 can be hollow. This configuration allows for a substance that can be frozen or heated to high temperatures, such as a gel or liquid, to be contained inside. In particular embodiments, at least one end of the elongate member 18 can be threaded such that at least one handle can be attached to the elongate member 18. In some embodiments, at least one end of the elongate member 18 can be smooth such that at least one handle can slide and/or suction to the elongate member 18. In particular embodiments, at least one end of the elongate member 18 can be tapered.

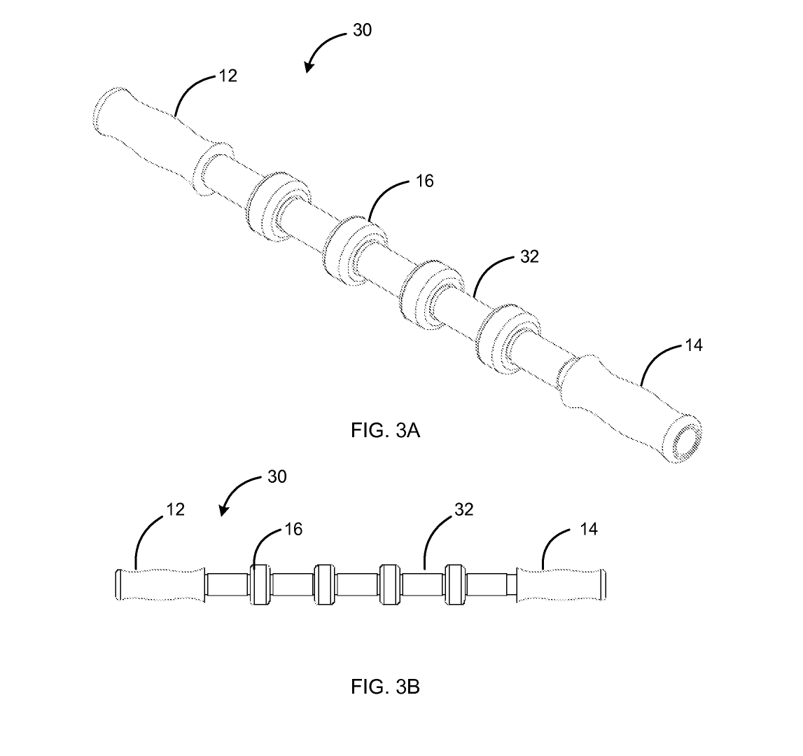

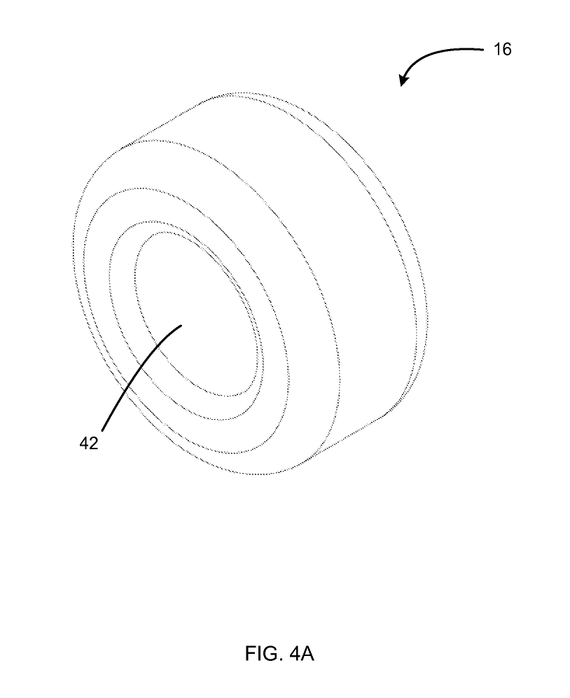

FIG. 3A is a schematic diagram that depicts a side view of a massage apparatus 30 including beads or spacers 32 positioned between the rollers according to an illustrative embodiment of the invention. A first handle 12 and a second handle 14 are shown. FIG. 3B is a schematic diagram that depicts a front view of the massage apparatus 30 including spacers 32 positioned between the rollers according to an illustrative embodiment of the invention. The spacers can provide the added therapeutic effect of a more targeted deep massage to a more concentrated area. The spacers can have a ring, donut or other elongate member receiving geometry.

FIG. 4A is a schematic diagram that depicts a perspective view of a roller 16 according to an illustrative embodiment of the invention. FIG. 4B is a schematic diagram that depicts a cross-sectional view of a roller 16 according to an illustrative embodiment of the invention. FIG. 4C is a schematic diagram that depicts a front view of a roller 16 according to an illustrative embodiment of the invention. The rollers 16 can turn slowly due to their size or a high friction surface between the roller 16 and the core 18 or they can spin quickly. The elongate member or core 18, and the rollers 16 can vary in size with respect to each other. In some embodiments, the hollow center portion 42 can be sized to just fit the elongate member 18 to allow for minimal rotation. In some embodiments, the hollow center portion 42 can be sized to about twice the diameter of the elongate member 18 to allow for maximal rotation about the elongate member 18.

In other embodiments, the rollers 16 can include a smooth outer surface to allow for smooth contact against the body part. In other embodiments, the rollers 16 can include a textured outer surface including for example ridges, grooves, bumps, etc. to allow for additional therapeutic effects. Varying the shape of the rollers 16 can yield desirable therapeutic effects, including a deeper or smoother massage. In particular embodiments, the rollers 16 can be ring-shaped, cylindrical, donut-shaped, spherical, elliptical or other three-dimensional shape. In particular embodiments, the rollers 16 can be made of a suitable material, including plastic, metal, wood, or ceramic.

In certain embodiments, the liquid or gel can be inserted into the rollers 16 by unscrewing a removable cap portion of the roller 16, pouring or injecting the liquid or gel into the interior cavity 44 of the roller 16, and twisting the removable portion of the roller 16 securely onto the roller 16. In some embodiments, the removable cap portion of the roller 16 and the bottom portion of the roller 16 can fit together for example through a push-fit mechanism, a screw cap mechanism, a welding mechanism, an adhesive or epoxy mechanism, or a mechanical fastening mechanism such as with screws, bolts, etc.

The fluid can be, e.g., a liquid or a gel or a solid capable of being heated or cooled, such as the freezable fluid found in infant teething toys. The fluid-filled rollers can be removed from the support stick and either heated, e.g., using a microwave oven, or cooled, e.g., using a freezer, to elicit a desired therapeutic effect. In one embodiment, the rollers are filled with heat retaining materials such as thermal energy storage materials that store heat and resist heat when chilled. In one embodiment, the thermal energy storage material can include a starch derived from wheat or rice.

In certain embodiments, the rollers can have a hole or fill port or tube through which the liquid or gel can be inserted or injected into the rollers 16. The hole or fill port or tube can be plugged or sealed for example by a push-fit mechanism, a screw cap mechanism, a welding mechanism, an adhesive or epoxy mechanism, or a mechanical fastening mechanism such as with screws, bolts, etc. In certain embodiments, the gel or liquid can be placed in the rollers 16 through molding or otherwise forming the roller 16 around the gel or liquid. In one embodiment, each roller includes two halves that connect together to form a seal by twisting together and locking along threaded edges.

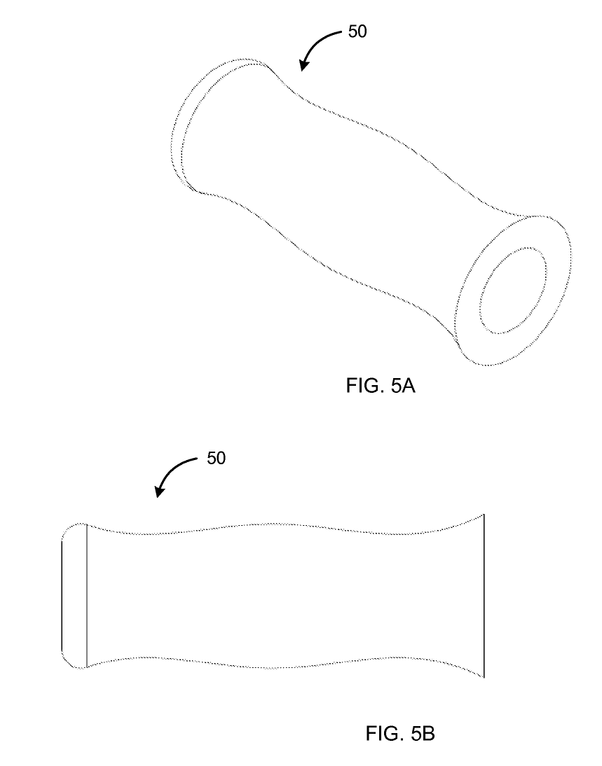

FIG. 5A is a schematic diagram that depicts a perspective view of the handle 50 according to an illustrative embodiment of the invention. FIG. 5B is a schematic diagram that depicts another view of a handle 50 that is in a detached state according to an illustrative embodiment of the invention. In some embodiments, the massage apparatus includes at least one handle. In some embodiments, the massage apparatus can have two handles to provide additional stability during the action of the massage apparatus.

In certain embodiments, the handle 50 can be made of a suitable material, including plastic, metal, ceramic, or foam. Generally, the handle 50 can vary in length, vary in diameter, and vary in shape for example straight, half-moon, circular, triangular, square, rectangular, or some other geometric shape. In certain embodiments, the handle 50 can be fixed to the elongate member 18 or the handle can be removable from the elongate member 18. In certain embodiments, the handle 50 can be straight, contoured, or snap-fit.

The first handle 12 and the second handle 14 can each be removed from the elongate member 18. The first handle 12 and the second handle 14 can each be removed, for example, by twisting, pulling, unfastening, unhooking, unlocking, or pushing a movable button.

In particular embodiments, the rollers 16 can be partially filled or completely filled with a gel or liquid. In particular embodiments, the liquid can be water or a suitable pre-made composition. In particular embodiments, the liquid or gel can be water-based. In particular embodiments, the liquid or gel can include a mixture of at least one of water, sodium chloride, minerals, and cellulose. In particular embodiments the liquid or gel can also include at least one of propylene glycol, hydroxypropyl methylcelluose, polyacrylate, and polyalcohol. In particular embodiments, the liquid or gel can be a substance capable of both heating and cooling. The rollers can each contain a liquid or gel that can be heated or the rollers can each contain a liquid or gel that can be cooled or the rollers can vary in containing a liquid or gel that can be heated and cooled.

In certain embodiments, the liquid or gel can be cooled by placing the entire massage apparatus 10, the individual rollers 16, or the liquid or gel itself in a freezer, refrigerator, or equivalent cooling massage apparatus thereof. In certain embodiments, the liquid or gel can be heated by placing the entire massage apparatus 10, the individual rollers 16, or the liquid or gel itself in a microwave, conventional oven, or equivalent heating apparatus thereof. The liquid or gel can include substances suitable for storing thermal energy for a time period P when in a liquid or gel state. In certain embodiments, the time period P can range from about 10 minutes to about 30 minutes. In certain embodiments, the time period P can range from about 30 minutes to about 60 minutes. In certain embodiments, the time period P can range from about 1 minute to about 10 minutes.

In particular embodiments a method of massaging an area of a body can be performed, the method comprising the steps of: removing a plurality of rollers from an elongate member having a length defined by a first end and a second end; a first handle connected to the first end of the therapeutic massage apparatus and a second handle connected to the second end of the therapeutic massage apparatus; and the plurality of rollers, the plurality of rollers capable of placement on the elongate member, the rollers comprising an interior cavity wherein the interior cavity contains a substance adaptable to heating or cooling; heating some or all of the plurality of rollers to a desired temperature; cooling some or all of the plurality of rollers to a desired temperature; placing the plurality of rollers onto the elongate member; maneuvering the elongate member across the area of the body; and applying a force such that the plurality of rollers contact the area of the body to provide a therapeutic effect across the area of the body.

The use of headings and sections in the application is not meant to limit the invention; each section can apply to any aspect, embodiment, or feature of the invention.

Throughout the application, where compositions are described as having, including, or comprising specific components, or where processes are described as having, including or comprising specific process steps, it is contemplated that compositions of the present teachings also consist essentially of, or consist of, the recited components, and that the processes of the present teachings also consist essentially of, or consist of, the recited process steps.

In the application, where an element or component is said to be included in and/or selected from a list of recited elements or components, it should be understood that the element or component can be any one of the recited elements or components and can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein.

The use of the terms “include,” “includes,” “including,” “have,” “has,” or “having” should be generally understood as open-ended and non-limiting unless specifically stated otherwise.

The use of the singular herein includes the plural (and vice versa) unless specifically stated otherwise. Moreover, the singular forms “a,” “an,” and “the” include plural forms unless the context clearly dictates otherwise. In addition, where the use of the term “about” is before a quantitative value, the present teachings also include the specific quantitative value itself, unless specifically stated otherwise. As used herein, the term “about” refers to a ±10% variation from the nominal value.

It should be understood that the order of steps or order for performing certain actions is immaterial so long as the present teachings remain operable. Moreover, two or more steps or actions may be conducted simultaneously.

Where a range or list of values is provided, each intervening value between the upper and lower limits of that range or list of values is individually contemplated and is encompassed within the invention as if each value were specifically enumerated herein. In addition, smaller ranges between and including the upper and lower limits of a given range are contemplated and encompassed within the invention. The listing of exemplary values or ranges is not a disclaimer of other values or ranges between and including the upper and lower limits of a given range.

The aspects, embodiments, features, and examples of the invention are to be considered illustrative in all respects and are not intended to limit the invention, the scope of which is defined only by the claims. Other embodiments, modifications, and usages will be apparent to those skilled in the art without departing from the spirit and scope of the claimed invention.

What is claimed is:

1. A massage apparatus comprising:
an elongate member having a length defined by a first end and a second end;
a first handle connected to the first end of the apparatus and a second handle connected to the second end of the apparatus; and
a plurality of rollers slidably disposed along the elongate member, each roller comprising:
an outer surface,
an interior cavity defined by the outer surface, wherein the interior cavity comprises a freezable or heatable liquid suitable for storing thermal energy for a time period P when in a liquid state; and
a hollow portion having an inner surface sized to receive the elongate member.

2. The apparatus of claim 1 wherein the rollers are each separated by one or more spacers.

3. The apparatus of claim 1 wherein the length of the elongate member is about 16 inches to about 2.5 feet.

4. The apparatus of claim 1 wherein one or both of the first handle and the second handle is removable.

5. The apparatus of claim 1 wherein the plurality of rollers is ring-shaped.

6. The apparatus of claim 1 wherein the rollers comprise at least one of plastic, ceramic, or stone.

7. The apparatus of claim 1 wherein the plurality of rollers slide onto the elongate member after one or both of the first handle and the second handle is removed.

8. The apparatus of claim 1 wherein the plurality of rollers clip on to the elongate member without removing one or both of the first handle or the second handle.

9. The apparatus of claim 1 where the substance in each roller stores or rejects heat.

10. The apparatus of claim 1 wherein the time period P ranges from about 10 minutes to about 30 minutes.

11. The apparatus of claim 1 wherein the liquid comprises at least one of water, sodium chloride, minerals, cellulose, propylene glycol, hydroxypropyl methylcelluose, polyacrylate, and polyalcohol.

12. The apparatus of claim 1 wherein the liquid is selected from the group consisting of water or a suitable pre-made composition.

13. A massage apparatus comprising:
a plurality of removable rollers, each roller comprising a donut-shaped shell and a liquid disposed within the shell, the shell having an outer diameter and defining a hole having an inner diameter;
a substantially cylindrical core having a core diameter, a first handle receiving end and a second handle receiving end, wherein the core diameter is sized relative to the inner diameter such that the core can slidably receive each roller and allow each roller to rotate relative to the core; and
a first handle and a second handle, each handle having an attachment point for connecting to one of the first handle receiving end or the second handle receiving end, wherein the liquid freezes in response to a reduction in temperature and stores heat in response to an increase in temperature, wherein after heating, the liquid stores thermal energy for at a least time period P.

14. The apparatus of claim 13 wherein the rollers are each separated by one or more spacers.

15. The apparatus of claim 13 wherein the length of the elongate member is about 16 inches to about 2.5 feet.

16. The apparatus of claim 13 wherein one or both of the first handle and the second handle is removable.

17. The apparatus of claim 13 wherein the rollers comprise at least one of plastic, ceramic, or stone.

18. The apparatus of claim 13 where the substance in each roller stores or rejects heat.

19. The apparatus of claim 13 wherein the time period P ranges from about 10 minutes to about 30 minutes.

20. The apparatus of claim 13 wherein the liquid comprises at least one of water, sodium chloride, minerals, cellulose, propylene glycol, hydroxypropyl methylcelluose, polyacrylate, and polyalcohol.
